(19) United States
(12) Patent Application Publication
(10) Pub. No.: US 2026/0089574 A1
(43) Pub. Date: Mar. 26, 2026

(54) COMMUNICATION CAPACITY ADJUSTMENT DEVICE, COMMUNICATION NETWORK SYSTEM, AND COMMUNICATION CAPACITY ADJUSTMENT METHOD

(71) Applicant: NEC Corporation, Tokyo (JP)

(72) Inventor: Masaru ETO, Tokyo (JP)

(73) Assignee: NEC Corporation, Tokyo (JP)

(21) Appl. No.: 19/318,685

(22) Filed: Sep. 4, 2025

(30) Foreign Application Priority Data
Sep. 20, 2024 (JP) 2024-164074

(51) Int. Cl. H04W 28/20; H04W 28/06; H04W 40/04

(52) U.S. Cl. CPC H04W 28/20; H04W 28/06; H04W 40/04

(57) ABSTRACT

A communication capacity adjustment device includes a communication capacity update circuit for, when there is one or more transmission sections in which a band usage rate for each transmission section is larger than a threshold, the band usage rate being a ratio obtained by dividing a value obtained by summing communication capacities set for all communication paths passing through one transmission section in a communication network by a transmission capacity set to each transmission section, repeating selecting one transmission section in which the band usage rate is larger than the threshold, and updating a communication capacity set for a communication path passing through the selected transmission section such that the band usage rate in the selected transmission section becomes equal to or less than the threshold until the band usage rate becomes equal to or less than the threshold in any of all the transmission sections.

This application is based upon and claims the benefit of priority from Japanese patent application No. 2024-164074, filed on Sep. 20, 2024, the disclosure of which is incorporated herein in its entirety by reference.

### TECHNICAL FIELD

The present disclosure relates to a communication capacity adjustment device, a communication network system, a communication capacity adjustment method, and a tangible and non-transitory recording medium storing a program.

### BACKGROUND ART

Communication settings may be dynamically updated in response to changes in the state of the communication network.

For example, in the method described in JP 2004-040793 A, a time stamp request is transmitted to each router on an end-to-end path to obtain a time stamp value. Then, in this method, the available bandwidth in the end-to-end path is estimated by using the obtained time stamp value. Estimating the available bandwidth can be regarded as setting an upper limit value of the bandwidth.

### SUMMARY

Even in a case where a plurality of communication paths pass through one transmission section (one link) in the communication network, the communication setting may be dynamically updated so that congestion does not occur.

An object of the present disclosure is to provide a communication capacity adjustment device, a communication network system, a communication capacity adjustment method, and a tangible and non-transitory recording medium storing a program that can solve the above-described problems.

According to a first aspect of the present disclosure, a communication capacity adjustment device includes a communication capacity update means for, in a case where there is one or more transmission sections in which a band usage rate for each transmission section is larger than a threshold, the band usage rate being a ratio obtained by dividing a value obtained by summing communication capacities set for all communication paths passing through one transmission section in a communication network by a transmission capacity set to each transmission section, repeating selecting one transmission section in which the band usage rate is larger than the threshold, and updating a communication capacity set for a communication path passing through the selected transmission section in such a way that the band usage rate in the selected transmission section becomes equal to or less than the threshold until the band usage rate becomes equal to or less than the threshold in any of all the transmission sections.

According to a second aspect of the present disclosure, a communication network system includes a transmission device and a communication capacity adjustment device, in which the communication capacity adjustment device includes a communication capacity update means for repeating, in a case where there is one or more transmission sections in which a band usage rate for each transmission section is larger than a set threshold, the band usage rate being a ratio obtained by dividing a value obtained by summing communication capacities set for all communication paths passing through one transmission section in a communication network by a transmission capacity set in each transmission section, among transmission sections that are portions between two transmission devices that directly perform communication in a communication network by the transmission device, selecting one transmission section in which the band usage rate is larger than the threshold, and updating a communication capacity set for a communication path passing through the selected transmission section in such a way that the band usage rate in the selected transmission section becomes equal to or less than the threshold until the band usage rate in all the transmission sections becomes equal to or less than the threshold set to the selected transmission section.

According to a third aspect of the present disclosure, a communication capacity adjustment method causes a computer to execute repeating, in a case where there is one or more transmission sections in which a band usage rate for each transmission section is larger than a threshold, the band usage rate being a ratio obtained by dividing a value obtained by summing communication capacities set for all communication paths passing through one transmission section in a communication network by a transmission capacity set to each transmission section, selecting one transmission section in which the band usage rate is larger than the threshold, and updating a communication capacity set for a communication path passing through the selected transmission section in such a way that the band usage rate in the selected transmission section becomes equal to or less than the threshold until the band usage rate in all the transmission sections becomes equal to or less than the threshold set to the selected transmission section.

According to a fourth aspect of the present disclosure, a program stored in a tangible and non-transitory recording medium causes a computer to execute repeating, in a case where there is one or more transmission sections in which a band usage rate for each transmission section is larger than a threshold, the band usage rate being a ratio obtained by dividing a value obtained by summing communication capacities set for all communication paths passing through one transmission section in a communication network by a transmission capacity set to each transmission section, selecting one transmission section in which the band usage rate is larger than the threshold, and updating a communication capacity set for a communication path passing through the selected transmission section in such a way that the band usage rate in the selected transmission section becomes equal to or less than the threshold until the band usage rate in all the transmission sections becomes equal to or less than the threshold set to the selected transmission section.

According to one aspect of the present disclosure, even in a case where a plurality of communication paths pass through one transmission section in a communication network, communication settings can be dynamically updated so that congestion does not occur.

### BRIEF DESCRIPTION OF THE DRAWINGS

FIG. 1 is a diagram illustrating an example of a configuration of a communication network system according to at least one example embodiment;

FIG. 2 is a diagram illustrating an example of a configuration of a communication device according to at least one example embodiment;

FIG. 3 is a diagram illustrating an example of a configuration of a transmission device according to at least one example embodiment;

FIG. 4 is a diagram illustrating an example of a configuration of a management device according to at least one example embodiment;

FIG. 5 is a diagram illustrating an example of a procedure of processing for setting a QoS parameter value in a communication network according to at least one example embodiment;

FIG. 6 is a diagram illustrating a first example of a state and setting of a communication network according to at least one example embodiment;

FIG. 7 is a diagram illustrating a first example of a bar-like representation of a state and setting of a communication network according to at least one example embodiment;

FIG. 8 is a diagram illustrating a second example of the state and setting of the communication network according to at least one example embodiment;

FIG. 9 is a diagram illustrating a second example of a bar-like representation of the state and setting of the communication network according to at least one example embodiment;

FIG. 10 is a diagram illustrating a third example of the state and setting of the communication network according to at least one example embodiment;

FIG. 11 is a diagram illustrating a third example of a bar-like representation of the state and setting of the communication network according to at least one example embodiment;

FIG. 12 is a diagram illustrating a fourth example of the state and setting of the communication network according to at least one example embodiment;

FIG. 13 is a diagram illustrating a fourth example of a bar-like representation of the state and setting of the communication network according to at least one example embodiment;

FIG. 14 is a diagram illustrating a fifth example of the state and setting of the communication network according to at least one example embodiment;

FIG. 15 is a diagram illustrating a fifth example of a bar-like representation of the state and setting of the communication network according to at least one example embodiment;

FIG. 16 is a diagram illustrating a sixth example of the state and setting of the communication network according to at least one example embodiment;

FIG. 17 is a diagram illustrating a sixth example of a bar-like representation of the state and setting of the communication network according to at least one example embodiment;

FIG. 18 is a diagram illustrating a seventh example of the state and setting of the communication network according to at least one example embodiment;

FIG. 19 is a diagram illustrating a seventh example of a bar-like representation of the state and setting of the communication network according to at least one example embodiment;

FIG. 20 is a diagram illustrating an example of a procedure of processing in which a QoS calculation unit according to at least one example embodiment calculates a QoS parameter value;

FIG. 21 is a diagram illustrating an example of a configuration of a communication capacity adjustment device according to at least one example embodiment;

FIG. 22 is a diagram illustrating an example of a configuration of a communication network system according to at least one example embodiment;

FIG. 23 is a diagram illustrating an example of a procedure of processing in a communication capacity adjustment method according to at least one example embodiment; and

FIG. 24 is a diagram illustrating an example of a configuration of a computer according to at least one example embodiment.

### EXAMPLE EMBODIMENT

Hereinafter, example embodiments according to the present disclosure will be described.

### First Example Embodiment

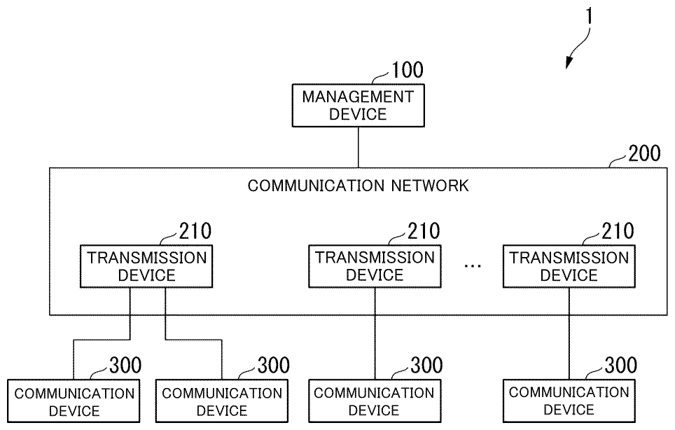

FIG. 1 is a diagram illustrating an example of a configuration of a communication network system according to at least one example embodiment. In the configuration illustrated in FIG. 1, a communication network system 1 includes a management device 100 and a communication network 200. The communication network 200 includes a transmission device 210.

FIG. 1 illustrates a communication device 300. The communication device 300 may be a part of the communication network system 1. Alternatively, the communication device 300 may have a configuration outside the communication network system 1.

The communication network system 1 performs communication between the communication devices 300 via the communication network 200.

The communication device 300 communicates with another communication device 300 via the communication network 200.

Hereinafter, a case where unicast communication is performed between two communication devices 300 will be described as an example. However, three or more communication devices 300 may perform communication by multicast or broadcast.

The transmission device 210 forms the communication network 200. One transmission device 210 constitutes one node of the communication network 200. The transmission device 210 transmits communication data between the communication devices 300.

In the communication network 200, a portion between two transmission devices 210 that perform direct communication is relevant to a link of the communication network 200. The link of the communication network 200 is also referred to as a transmission section. The amount of data communicable per unit time in each transmission section is also referred to as a transmission capacity in the transmission section or a transmission capacity in the transmission section.

The management device 100 manages quality of service (QoS) of communication between the communication devices 300. In particular, the management device 100 determines an upper limit value of the communicable data amount per unit time for the communication path between the communication devices 300. The amount of data communicable per unit time on a communication path is also referred to as a communication capacity of the communication path or a communication capacity of the communication path. The amount of data communicable per unit time on a communication path can also be referred to as a bandwidth of the communication path or a communication speed upper limit setting value.

The management device 100 can be regarded as an example of a network management system (NMS). The management device 100 may include, for example, a computer such as a workstation (WS).

The communication path between the communication devices 300 is also simply referred to as a communication path. The communication path is also referred to as a path. The communication path includes a virtual local area network (VLAN), but not limited thereto.

The communication capacity is relevant to an example of a QoS parameter value. The management device 100 determines a QoS parameter value for each communication path.

Hereinafter, a case where the transmission devices 210 perform wireless communication will be described as an example. That is, a case where the communication network 200 is a wireless communication network will be described as an example. In a wireless communication network, a transmission capacity in a certain transmission section may temporarily change due to an external factor such as rainfall. Therefore, when the transmission capacity in a certain transmission section temporarily decreases (being lowered), the management device 100 decreases the communication capacity in the communication path passing through the transmission section so that congestion does not occur.

The communication path passing through a certain transmission section is a communication path using the transmission section as a part of the communication path.

However, the communication network 200 is not limited to a wireless communication network, and can be various communication networks whose transmission capacity can change. For example, a plurality of communication networks may share one or more transmission paths (links), and the allocation of the communication capacity in the transmission path to each communication network may be dynamically updated.

The transmission device 210 and the communication device 300 may be integrally configured. For example, the transmission device 210 may have the function of the communication device 300 in addition to the function of the transmission device 210.

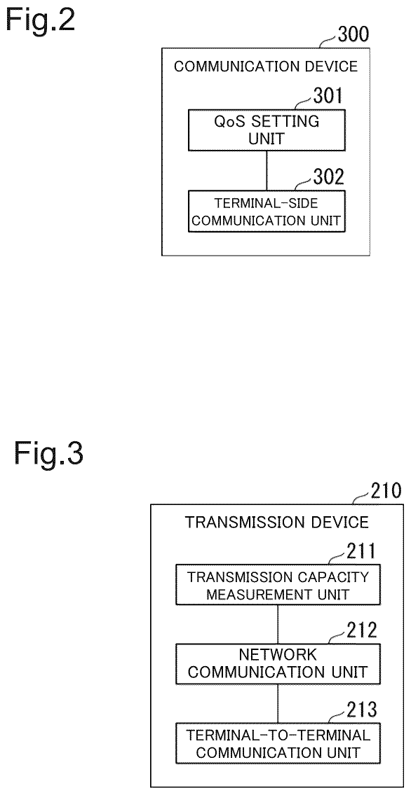

FIG. 2 is a diagram illustrating an example of a configuration of the communication device 300. In the configuration illustrated in FIG. 2, the communication device 300 includes a QoS setting unit 301 and a terminal-side communication unit 302.

The QoS setting unit 301 sets the QoS parameter value determined by the management device 100 for the communication path in the communication of its own device as the QoS parameter value of the communication by its own management device 100. As used herein, for a part of a device, its own device is a device including the part.

In particular, the QoS setting unit 301 sets the communication capacity determined by the management device 100 as the communication capacity of the communication performed by its own communication device 300 (the communication capacity of the communication path in the communication performed by its own communication device 300).

The terminal-side communication unit 302 communicates with the terminal-side communication unit 302 of another communication device 300 via the communication network 200. At that time, the terminal-side communication unit 302 performs communication according to the QoS parameter value set by the QoS setting unit 301. In particular, the terminal-side communication unit 302 performs communication at a communication speed equal to or lower than the communication capacity set by the QoS setting unit 301.

The communication device 300 can be regarded as a device at an end of a communication path using the communication network 200. In this respect, the communication device 300 can be regarded as a communication terminal device for the communication network 200.

FIG. 3 is a diagram illustrating an example of a configuration of the transmission device 210. In the configuration illustrated in FIG. 3, the transmission device 210 includes a transmission capacity measurement unit 211, a network communication unit 212, and a terminal-to-terminal communication unit 213.

The transmission capacity measurement unit 211 measures a transmission capacity in a transmission section (a link directly connected to its own transmission device 210) in which its own transmission device 210 performs communication. In a case where there is a plurality of transmission sections in which the own transmission device 210 performs communication, the transmission capacity measurement unit 211 measures the transmission capacity for each transmission section.

The transmission capacity measurement unit 211 notifies the management device 100 of the measurement result of the transmission capacity.

For example, regarding the communication of the measurement result of the transmission capacity, the management device 100 may be treated as the communication device 300. Then, the transmission capacity measurement unit 211 may transmit the measurement result of the transmission capacity to the management device 100 via the terminal-to-terminal communication unit 213. Alternatively, the transmission capacity measurement unit 211 may transmit the measurement result of the transmission capacity to the management device 100 via the network communication unit 212 and one or more other transmission devices 210.

The transmission capacity measurement unit 211 may notify the management device 100 of the measurement result of the transmission capacity only in a case where the transmission capacity changes.

The method by which the transmission capacity measurement unit 211 measures the transmission capacity in the transmission section is not limited to a specific method. A known method may be used as a method by which the transmission capacity measurement unit 211 measures the transmission capacity in the transmission section.

Only the transmission device 210 at one of both ends of the transmission path (link) may measure the transmission capacity.

In addition to or instead of the transmission device 210, the communication device 300 may estimate the transmission capacity in the transmission section. In this case, the communication device 300 may include the transmission capacity measurement unit 211 in addition to or instead of the transmission device 210.

The network communication unit 212 performs communication using the communication network 200. In particular, the network communication unit 212 communicates with the network communication unit 212 of another transmission device 210 (transmission of communication data between the communication devices 300). The communication performed by the network communication unit 212 can be regarded as a function of the transmission device 210 as a node of the communication network 200.

The terminal-to-terminal communication unit 213 communicates with the terminal-side communication unit 302 of the communication device 300.

In particular, the terminal-to-terminal communication unit 213 transmits and receives communication data between the terminal-side communication unit 302 and the communication device 300. The terminal-to-terminal communication unit 213 causes the network communication unit 212 to transmit the communication data received from the communication device 300 to the communication device 300 as a communication partner via the communication network 200. The terminal-to-terminal communication unit 213 transmits the communication data received by the network communication unit 212 from the communication device 300 of the communication partner via the communication network 200 to the communication device 300 (the communication device 300 to which the terminal-to-terminal communication unit 213 itself is communicatively connected).

A plurality of communication devices 300 may be communicably connectable to one transmission device 210 at the same time. There may be a transmission device 210 to which the communication device 300 is not connected for communication.

A communication scheme between the terminal-to-terminal communication unit 213 and the terminal-side communication unit 302 of the communication device 300 is not limited to a specific communication scheme. The terminal-to-terminal communication unit 213 and the terminal-side communication unit 302 may perform wireless communication or wired communication.

Hereinafter, as a communication speed in communication between the communication device 300 and the transmission device 210 (communication between the terminal-side communication unit 302 and the terminal-to-terminal communication unit 213), a case where a communication speed equal to or higher than a communication capacity set for the relevant communication path can be secured will be described as an example.

Alternatively, the communication path between the communication device 300 and the transmission device 210 may also be included in the target of measurement of the transmission capacity and the target of calculation of the QoS parameter value by the management device 100 as a part of the communication network 200.

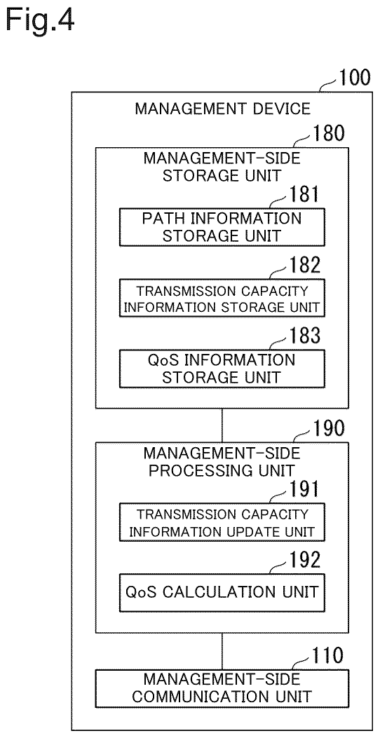

FIG. 4 is a diagram illustrating an example of a configuration of the management device 100. In the configuration illustrated in FIG. 4, the management device 100 includes a management-side communication unit 110, a management-side storage unit 180, and a management-side processing unit 190.

The management-side storage unit 180 includes a path information storage unit 181, a transmission capacity information storage unit 182, and a QoS information storage unit 183. The management-side processing unit 190 includes a transmission capacity information update unit 191 and a QoS calculation unit 192.

The management-side communication unit 110 communicates with other devices.

In particular, the management-side communication unit 110 receives the measurement value of the transmission capacity by the transmission capacity measurement unit 211 of the transmission device 210. The management-side communication unit 110 may receive the measurement value of the transmission capacity from the transmission device 210 via the communication network 200.

The management-side communication unit 110 transmits the QoS parameter value determined by the management device 100 to the communication device 300. The management-side communication unit 110 may transmit the QoS parameter value to the communication device 300 via the communication network 200.

The management-side storage unit 180 stores various pieces of data. The management-side storage unit 180 is configured using a storage device included in the management device 100.

The path information storage unit 181 stores information in which a communication path and a transmission section through which the communication path passes are associated with each other. Information in which a communication path and a transmission section through which the communication path passes are associated with each other is also referred to as path information.

In the path information stored in the path information storage unit 181, the transmission section can be searched for from the communication path, and the communication path can be searched for from the transmission section.

The transmission capacity information storage unit 182 stores information indicating (the measurement value of) the transmission capacity for each transmission section. Information indicating the transmission capacity for each transmission section is also referred to as transmission capacity information.

The QoS information storage unit 183 stores information indicating a QoS parameter value for each communication path. Information indicating the QoS parameter value for each communication path is also referred to as QoS information. The QoS information stored in the QoS information storage unit 183 particularly indicates a communication capacity for each communication path.

The management-side processing unit 190 controls each unit of the management device 100 to execute various types of processing. The function of the management-side processing unit 190 is executed, for example, when a central processing unit (CPU) included in the management device 100 reads a program from the management-side storage unit 180 and executes the program.

The transmission capacity information update unit 191 updates the transmission capacity information stored in the transmission capacity information storage unit 182. Specifically, when the management-side communication unit 110 receives the measurement value of the transmission capacity, the transmission capacity information update unit 191 writes the received transmission capacity in the transmission capacity information of the transmission capacity information update unit 191. The transmission capacity information update unit 191 may update the transmission capacity information only in a case where the transmission capacity changes.

The QoS calculation unit 192 calculates the QoS parameter value and determines the calculated value.

The QoS calculation unit 192 is relevant to an example of a communication capacity update means.

Specifically, the QoS calculation unit 192 calculates a QoS parameter value for each communication path, and writes the calculated value into the QoS information in the QoS information storage unit 183. Writing the QoS parameter value into the QoS information in the QoS information storage unit 183 by the QoS calculation unit 192 can be regarded as determining the QoS parameter value.

In particular, when the transmission capacity in a certain transmission section changes, the QoS calculation unit 192 determines (updates) the communication capacity in each communication path passing through the transmission section so that the sum of the communication capacities in the communication paths passing through the transmission section does not exceed the changed transmission capacity.

More specifically, for all communication paths passing through a certain transmission section, the QoS calculation unit 192 determines the communication capacity in each communication path passing through the transmission section such that a ratio obtained by dividing a value obtained by summing the communication capacities set for the communication paths by the transmission capacity in the transmission section is equal to or less than a threshold.

For all communication paths passing through a certain transmission section, a ratio obtained by dividing a value obtained by summing communication capacities set for the communication paths by a transmission capacity in the transmission section is also referred to as a band usage rate or simply as a usage rate.

The threshold for the band usage rate is also referred to as a usage rate upper limit threshold, or simply as a threshold. The usage rate upper limit threshold is set to a value within a range from 0% to 100%.

For example, in order to make the most effective use of the transmission capacity in the transmission path, the usage rate upper limit threshold in the transmission path may be set to 100%. Alternatively, in order to provide a margin of the transmission capacity so that congestion does not occur when the transmission capacity changes, the usage rate upper limit threshold may be set to a value smaller than 100%, for example, 80%.

The usage rate upper limit threshold may be determined in advance for each transmission section by an administrator of the communication network 200.

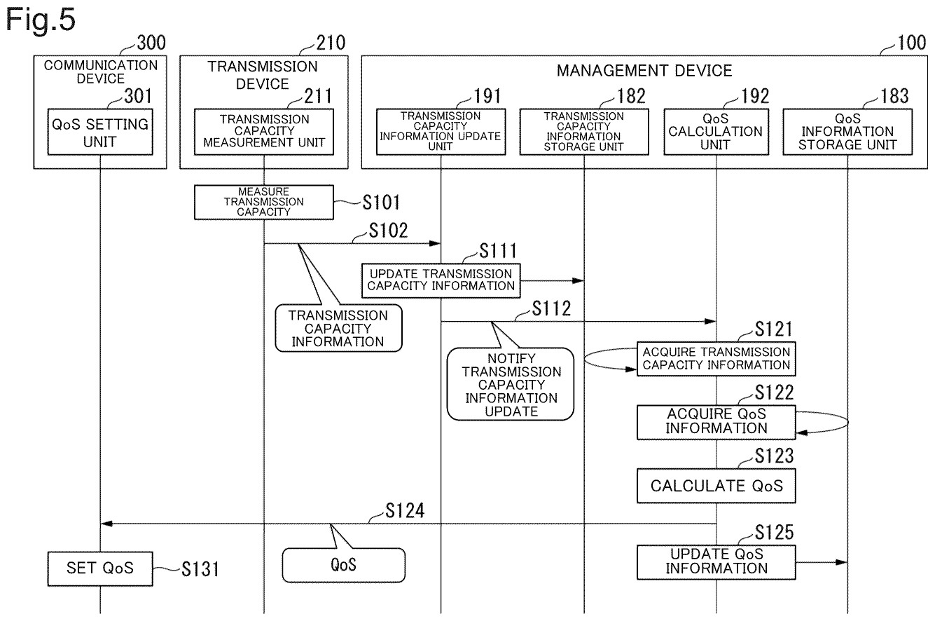

FIG. 5 is a diagram illustrating an example of a procedure of processing for setting a QoS parameter value in the communication network 200.

In the processing illustrated in FIG. 5, the transmission capacity measurement unit 211 of the transmission device 210 measures the transmission capacity in the transmission path (link) directly connected to its own transmission device 210 (step S101). The transmission capacity measurement unit 211 may periodically measure the transmission capacity. Alternatively, the transmission capacity measurement unit 211 may measure the transmission capacity with the occurrence of some event such as a change in weather or a change in the communication speed of its own transmission device 210 as a trigger.

The transmission capacity measurement unit 211 notifies the management device 100 of the measurement value of the transmission capacity (step S102). For example, the transmission capacity measurement unit 211 transmits the transmission capacity information indicating the measurement value of the transmission capacity to the management device 100 via the network communication unit 212 and the communication network 200 or via the terminal-to-terminal communication unit 213.

Next, the transmission capacity information update unit 191 of the management device 100 updates the transmission capacity information stored in the transmission capacity information storage unit 182 (step S111). Specifically, the transmission capacity information update unit 191 updates the transmission capacity information so as to reflect the measurement value of the transmission capacity notified from the transmission capacity measurement unit 211 in the transmission capacity information stored in the transmission capacity information storage unit 182.

The transmission capacity information update unit 191 notifies the QoS calculation unit 192 that the transmission capacity information has been updated (step S112). The notification that the transmission capacity information has been updated is also referred to as a transmission capacity information update notification.

The QoS calculation unit 192 that has received the transmission capacity information update notification calculates a QoS parameter value based on the updated transmission capacity (steps S121 to S123).

In the calculation of the QoS parameter value, the QoS calculation unit 192 reads the transmission capacity information stored in the transmission capacity information storage unit 182 (step S121).

The QoS calculation unit 192 reads the QoS information stored in the QoS information storage unit 183 (step S122).

Then, the QoS calculation unit 192 calculates a QoS parameter value with which congestion does not occur in each transmission section based on the acquired transmission capacity information and QoS information (step S123). In particular, the QoS calculation unit 192 calculates the communication capacity for each communication path such that the band usage rate in each transmission section does not exceed the threshold.

Then, the QoS calculation unit 192 notifies the communication device 300 of the calculated QoS parameter value (step S124). Specifically, the QoS calculation unit 192 transmits the calculated QoS parameter value to the communication device 300 via the management-side communication unit 110 and the communication network 200.

The QoS calculation unit 192 updates the QoS information stored in the QoS information storage unit 183 (step S125). Specifically, the QoS calculation unit 192 rewrites the QoS parameter value stored in the QoS information by the QoS information storage unit 183 to the calculated value.

In the communication device 300 that has received the QoS parameter value, the QoS setting unit 301 updates the QoS parameter value set as the communication setting by the terminal-side communication unit 302 to the received QoS parameter value (step S131).

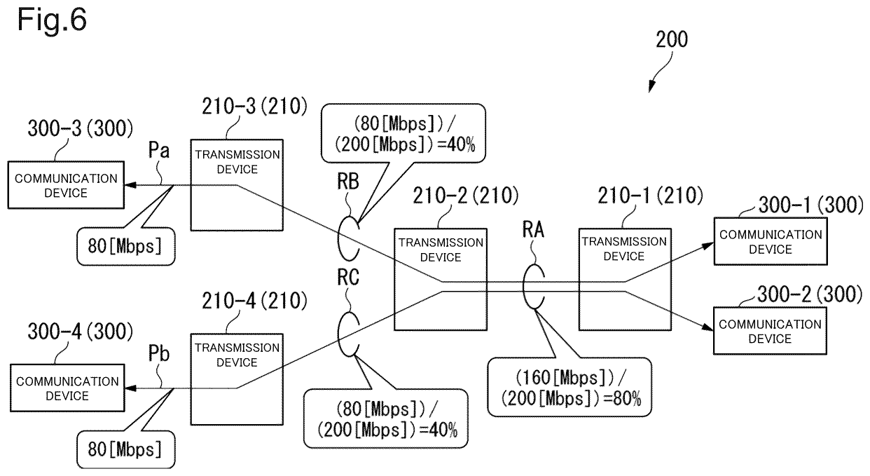

FIG. 6 is a diagram illustrating a first example of the state and setting of the communication network 200. In the example of FIG. 6, the communication network 200 includes four transmission devices 210. In a case where these four transmission devices 210 are distinguished, they are also referred to as transmission devices 210-1, 210-2, 210-3, and 210-4.

Links (transmission paths) are provided between the transmission devices 210-1 and 210-2, between the transmission devices 210-2 and 210-3, and between the transmission devices 210-2 and 210-4. A section between the transmission devices 210-1 and 210-2 is also referred to as a transmission section RA. A section between the transmission devices 210-2 and 210-3 is also referred to as a transmission section RB. A section between the transmission devices 210-2 and 210-4 is also referred to as a transmission section RC.

In the example of FIG. 6, four communication devices 300 are communicably connected to the communication network 200. In a case where these four communication devices 300 are distinguished, they are also referred to as communication devices 300-1, 300-2, 300-3, and 300-4.

Each of the communication devices 300-1 and 300-2 is communicably connected to the transmission device 210-1. The communication device 300-3 is communicably connected to the transmission device 210-3. The communication device 300-4 is communicably connected to the transmission device 210-4.

The communication devices 300-1 and 300-3 communicate with each other, and the communication devices 300-2 and 300-4 communicate with each other.

A communication path between the communication devices 300-1 and 300-3 is also referred to as a communication path Pa. The communication path Pa passes through the transmission sections RA and RB.

A communication path between the communication devices 300-2 and 300-4 is also referred to as a communication path Pb. The communication path Pb passes through the transmission sections RA and RC.

For example, in mobile backhaul, it is conceivable that the network has a tree structure as illustrated in FIG. 6, and it is conceivable that it is difficult to switch the communication path so as to make a detour in a case where the transmission capacity deteriorates. In this case, it is conceivable to adjust the QoS control so that congestion does not occur.

The mobile backhaul here is a communication network by a plurality of radio base stations (transmission devices in the example of FIG. 6). The mobile backhaul may be connected to a core network (backbone line). In the example of FIG. 6, the transmission device 210-1 may communicate with each of the communication devices 300-1 and 300-2 via the core network.

In the example of FIG. 6, the communication capacity of the communication path Pa is set to 80 megabits per second (Mbps). The communication capacity of the communication path Pb is also set to 80 megabits per second.

It is assumed that the communication capacity of each of the communication paths Pa and Pb can be set within a range from 0 megabits per second to 80 megabits per second. The range of the communication capacity that can be set in the communication path may be determined according to the specification of the device such as the specification of the communication device 300. Alternatively, the range of the communication capacity that can be set in the communication path may be artificially defined, such as defined in the communication service provision contract.

The transmission capacity in the transmission section RA is 200 megabits per second. The QoS calculation unit 192 calculates the band usage rate in the transmission section RA as (80+80)/200=80%.

The transmission capacity in the transmission section RB is also 200 megabits per second. The QoS calculation unit 192 calculates the band usage rate in the transmission section RB as 80/200=40%.

The transmission capacity in the transmission section RC is also 200 megabits per second. The QoS calculation unit 192 calculates the band usage rate in the transmission section RC as 80/200=40%.

In any of the transmission sections RA, RB, and RC, the band usage rate is equal to or less than 100%, and it is considered that congestion does not occur.

It is assumed that the usage rate upper limit threshold is set to 100% in any of the transmission sections RA, RB, and RC. In any of the transmission sections RA, RB, and RC, the band usage rate is a value equal to or less than the usage rate upper limit threshold.

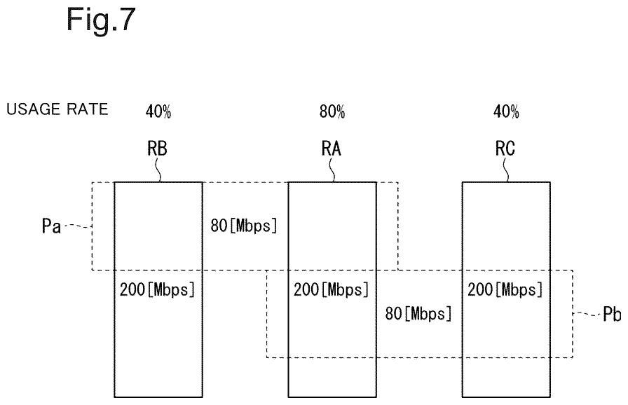

FIG. 7 is a diagram illustrating a first example of a bar-like representation of the state and setting of the communication network 200. FIG. 7 illustrates an example in which the state and setting of the communication network 200 in FIG. 6 are expressed in a bar graph manner.

In the example of FIG. 7, the transmission capacities in the transmission sections RA, RB, and RC are indicated by the heights of solid squares. The communication capacity in each of the communication paths Pa and Pb is indicated by the height of a dashed square.

The band usage rate in each transmission section is indicated by a ratio obtained by dividing the sum of the heights indicating the communication capacity in the communication path passing through the transmission section by the height indicating the transmission capacity in the transmission section.

In the example of FIG. 7, in any of the transmission sections RA, RB, and RC, the height indicating the transmission capacity is larger than the sum of the heights indicating the communication capacity, and it is indicated that congestion does not occur.

The management device 100 may visually express the state and setting of the communication network 200 as in the example of FIG. 7.

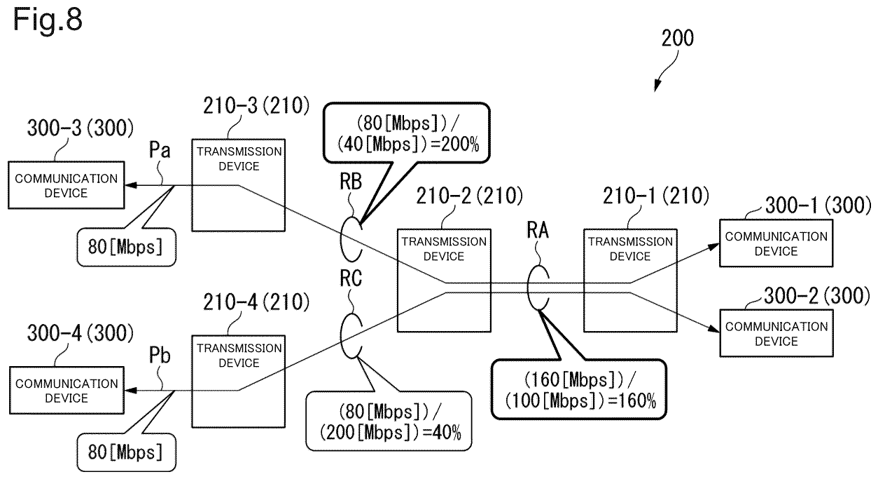

FIG. 8 is a diagram illustrating a second example of the state and setting of the communication network 200. FIG. 8 illustrates an example of a case where the transmission capacity changes from the example of FIG. 6.

In the example of FIG. 8, the transmission capacity in the transmission section RA is 100 megabits per second.

The QoS calculation unit 192 calculates the band usage rate in the transmission section RA as 160/100=160%.

The transmission capacity in the transmission section RB is 40 megabits per second. The QoS calculation unit 192 calculates the band usage rate in the transmission section RB as 80/40=200%.

As described above, the band usage rate is larger than 100% in each of the transmission sections RA and RB, and congestion may occur in these transmission sections.

In each of the transmission sections RA and RB, the band usage rate is a value larger than the usage rate upper limit threshold. In this case, the QoS calculation unit 192 updates the QoS parameter value such that the band usage rate is equal to or less than the threshold.

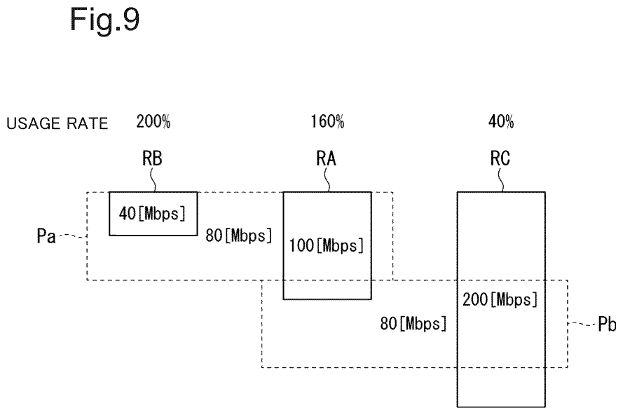

FIG. 9 is a diagram illustrating a second example of a bar-like representation of the state and setting of the communication network 200. FIG. 9 illustrates an example in which the state and setting of the communication network 200 in FIG. 8 are expressed in a bar graph manner.

Also in the example of FIG. 9, the transmission capacity in each of the transmission sections RA, RB, and RC is indicated by the height of a solid square. The communication capacity in each of the communication paths Pa and Pb is indicated by the height of a dashed square.

In the example of FIG. 9, the sum of the height indicating the communication capacity in the communication path Pa and the height indicating the communication capacity in the communication path Pb is larger than the height indicating the transmission capacity in the transmission section RA. This indicates that congestion may occur in the transmission section RA.

The height indicating the communication capacity in the communication path Pa is larger than the height indicating the transmission capacity in the transmission section RB. This indicates that congestion may occur in the transmission section RB.

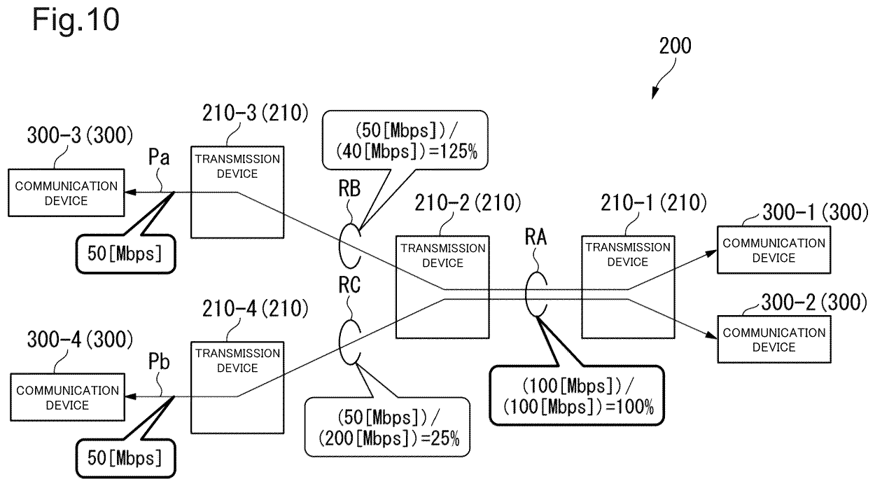

FIG. 10 is a diagram illustrating a third example of the state and setting of the communication network 200. FIG. 10 illustrates a first example in a case where the QoS calculation unit 192 adjusts the QoS parameter value for the first time from the example of FIG. 8.

Referring to FIG. 8 illustrating the state before calculation in the example of FIG. 10, the band usage rates of the transmission sections RA and RB are larger than the usage rate upper limit threshold. In the example of FIG. 10, the QoS calculation unit 192 selects the transmission section RA from the transmission sections RA and RB in which the band usage rate is larger than the threshold.

In the example of FIG. 10, the transmission section RA is relevant to an example of a transmission section in which a difference obtained by subtracting a threshold from a band usage rate is smallest among transmission sections in which the band usage rate is larger than the threshold. The transmission section RA also is relevant to an example of a transmission section in which the number of communication paths passing through the transmission section is largest among the transmission sections in which the band usage rate is larger than the threshold.

The QoS calculation unit 192 calculates the communication capacity of each of the communication paths Pa and Pb passing through the transmission section RA such that the band usage rate in the selected transmission section RA becomes 100% that is the usage rate upper limit threshold.

Specifically, the QoS calculation unit 192 calculates (80+80)−100=60 [Mbps] obtained by subtracting the transmission capacity in the transmission section RA from the sum of the (pre-change) communication capacities of the communication paths Pa and Pb as the communication capacity to be subtracted.

Then, the QoS calculation unit 192 distributes the communication capacities to be subtracted according to a ratio of 80:80 of the communication capacities of the communication paths Pa and Pb, and calculates the communication capacities to be subtracted for the communication paths Pa and Pb as 30 megabits per second and 30 megabits per second.

The QoS calculation unit 192 calculates the communication capacity of the communication path Pa as 80−30=50 [Mbps]. The QoS calculation unit 192 calculates the communication capacity of the communication path Pb as 80−30=50 [Mbps].

The QoS calculation unit 192 calculates the band usage rate in the transmission section RA based on the calculated communication capacity as (50+50)/100=100%.

The QoS calculation unit 192 calculates the band usage rate in the transmission section RB based on the calculated communication capacity as 50/40=125%. The QoS calculation unit 192 calculates the band usage rate in the transmission section RC based on the calculated communication capacity as 50/200=25%.

As described above, the band usage rate is greater than 100% in the transmission section RB, and congestion may occur in the transmission section RB.

In the transmission section RB, the band usage rate is a value larger than the usage rate upper limit threshold. Therefore, the QoS calculation unit 192 recalculates the QoS parameter value such that the band usage rate is equal to or less than the threshold.

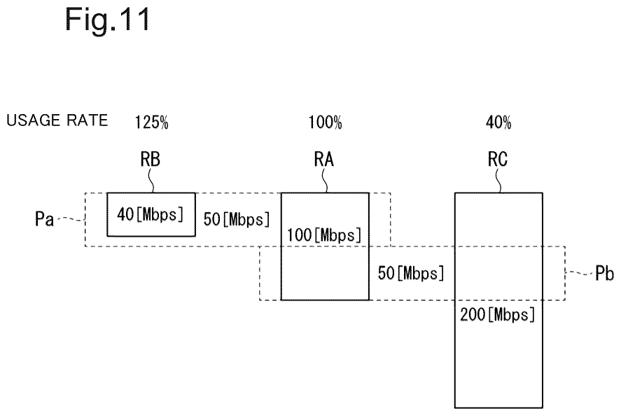

FIG. 11 is a diagram illustrating a third example of a bar-like representation of the state and setting of the communication network 200. FIG. 11 illustrates an example in which the state and setting of the communication network 200 based on the communication capacity calculated by the QoS calculation unit 192 in FIG. 10 are expressed in a bar graph manner.

Also in the example of FIG. 11, the transmission capacity in each of the transmission sections RA, RB, and RC is indicated by the height of a solid square. The communication capacity in each of the communication paths Pa and Pb is indicated by the height of a dashed square.

In the example of FIG. 11, the height indicating the transmission capacity in the transmission section RA is equal to the sum of the height indicating the communication capacity in the communication path Pa and the height indicating the communication capacity in the communication path Pb. This indicates that congestion does not occur in the transmission section RA.

On the other hand, the height indicating the communication capacity in the communication path Pa is larger than the height indicating the transmission capacity in the transmission section RB. This indicates that congestion may occur in the transmission section RB.

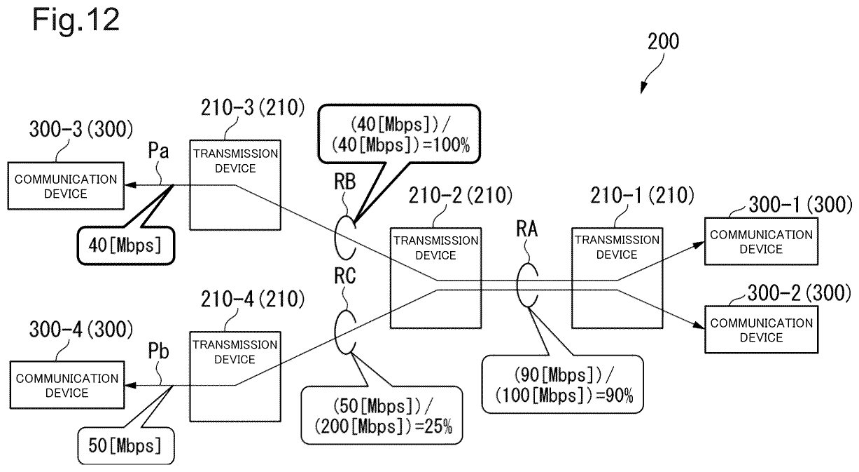

FIG. 12 is a diagram illustrating a fourth example of the state and setting of the communication network 200. FIG. 12 illustrates an example in a case where the QoS calculation unit 192 adjusts the QoS parameter value for the second time from the example of FIG. 10.

Referring to FIG. 10 illustrating a state before calculation in the example of FIG. 12, the transmission section in which the band usage rate is larger than the threshold is only the transmission section RB, and in the example of FIG. 12, the QoS calculation unit 192 selects the transmission section RB.

Then, the QoS calculation unit 192 calculates the communication capacity of the communication path Pa passing through the transmission section RB such that the band usage rate in the selected transmission section RB becomes 100% that is the usage rate upper limit threshold.

Specifically, the QoS calculation unit 192 calculates the communication capacity of the communication path Pa to be 40 megabits per second equal to the transmission capacity of the transmission section RB.

The QoS calculation unit 192 calculates the band usage rate in the transmission section RB based on the calculated communication capacity as 40/40=100%. The QoS calculation unit 192 calculates the band usage rate in the transmission section RA based on the calculated communication capacity as (40+50)/100=90%.

In the example of FIG. 12, in any of the transmission sections RA, RB, and RC, the band usage rate is equal to or less than 100%, and it is considered that congestion does not occur.

In both the transmission sections RA and RC through which the communication path Pb passes, the band usage rate is smaller than the usage rate condition threshold. The communication capacity of the communication path Pb is calculated to be 50 megabits per second smaller than the upper limit value of 80 megabits per second.

As described above, in a case where there is a communication path whose band usage rate in all the transmission sections through which one communication path passes is smaller than the usage rate upper limit threshold and the communication capacity in the communication path is smaller than the settable upper limit value, it can be understood that there is a margin to increase the communication capacity in the communication path. Therefore, the QoS calculation unit 192 recalculates the QoS parameter value so as to increase the communication capacity on the communication path.

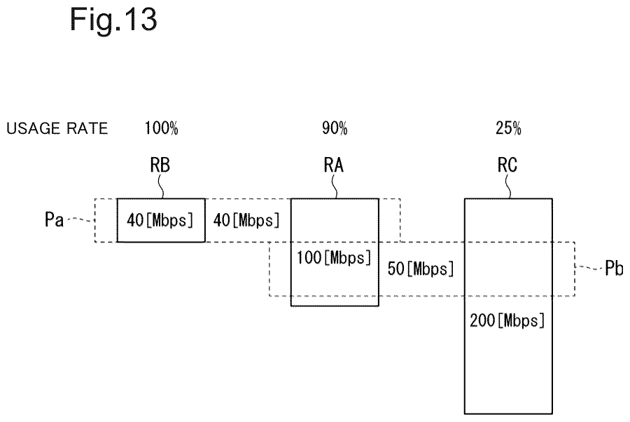

FIG. 13 is a diagram illustrating a fourth example of a bar-like representation of the state and setting of the communication network 200. FIG. 13 illustrates an example in which the state and setting of the communication network 200 based on the communication capacity calculated by the QoS calculation unit 192 in FIG. 12 are expressed in a bar graph manner.

Also in the example of FIG. 13, the transmission capacity in each of the transmission sections RA, RB, and RC is indicated by the height of a solid square. The communication capacity in each of the communication paths Pa and Pb is indicated by the height of a dashed square.

In the example of FIG. 13, in any of the transmission sections RA, RB, and RC, the height indicating the transmission capacity is greater than or equal to the sum of the heights indicating the communication capacity, and it is indicated that congestion does not occur.

In the example of FIG. 13, the band usage rate is less than 100% in both the transmission sections RA and RC through which the communication path Pb passes. This indicates that the communication capacity on the communication path Pb (depending on the usage rate upper limit threshold) may be increased.

The fact that the band usage rate is less than 100% is indicated by the fact that the sum of the heights indicating the communication capacity is less than the height indicating the transmission capacity.

In a case where the management device 100 visually expresses the state and setting of the communication network 200 as in the example of FIG. 13, a value obtained by multiplying the transmission capacity by the usage rate upper limit threshold may be visually expressed in addition to or instead of the transmission capacity. By comparing the magnitude of the value obtained by multiplying the transmission capacity by the usage rate upper limit threshold with the magnitude of the sum of the communication capacities, it is possible to grasp whether it is necessary to change the QoS parameter value and whether the communication capacity can be increased.

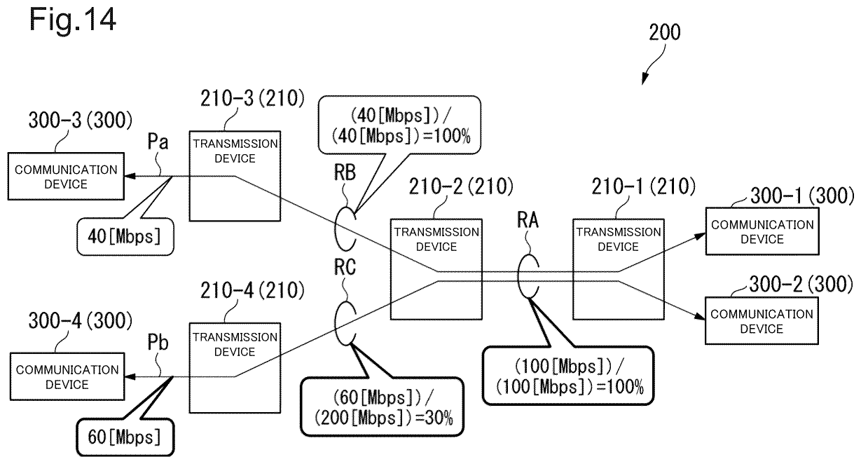

FIG. 14 is a diagram illustrating a fifth example of the state and setting of the communication network 200. FIG. 14 illustrates an example in a case where the QoS calculation unit 192 adjusts the QoS parameter value for the third time from the example of FIG. 12.

In the example of FIG. 14, the QoS calculation unit 192 recalculates the QoS parameter value such that the communication capacity on the communication path Pb becomes larger.

Specifically, the QoS calculation unit 192 calculates the increasable amount of the transmission capacity in the transmission section RA as 100−90=10 [Mbps]. The QoS calculation unit 192 calculates the increasable amount of the transmission capacity in the transmission section RC as 200−50=150 [Mbps].

Then, the QoS calculation unit 192 selects minimum 10 megabits per second of the calculated increasable amount as the increasable amount of the communication capacity on the communication path Pb. Then, the QoS calculation unit 192 calculates the increased communication capacity of the communication path Pb as 50+10=60 [Mbps].

The QoS calculation unit 192 calculates the band usage rate in the transmission section RA based on the calculated communication capacity as (40+60)/100=100%. The QoS calculation unit 192 calculates the band usage rate in the transmission section RC based on the calculated communication capacity as 60/200=30%.

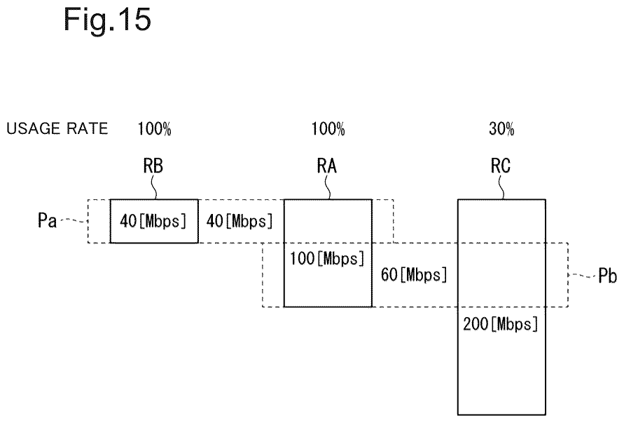

FIG. 15 is a diagram illustrating a fifth example of a bar-like representation of the state and setting of the communication network 200. FIG. 15 illustrates an example in which the state and setting of the communication network 200 based on the communication capacity calculated by the QoS calculation unit 192 in FIG. 14 are expressed in a bar graph manner.

Also in the example of FIG. 15, the transmission capacity in each of the transmission sections RA, RB, and RC is indicated by the height of a solid square. The communication capacity in each of the communication paths Pa and Pb is indicated by the height of a dashed square.

In the example of FIG. 15, in any of the transmission sections RA, RB, and RC, the height indicating the transmission capacity is greater than or equal to the sum of the heights indicating the communication capacity, and it is indicated that congestion does not occur.

In the example of FIG. 15, the total communication capacities and the transmission capacity are equal in the transmission section RA through which both the communication paths Pa and Pb pass. This indicates that there is no margin of the transmission capacity for increasing the communication capacity for both the communication paths Pa and Pb.

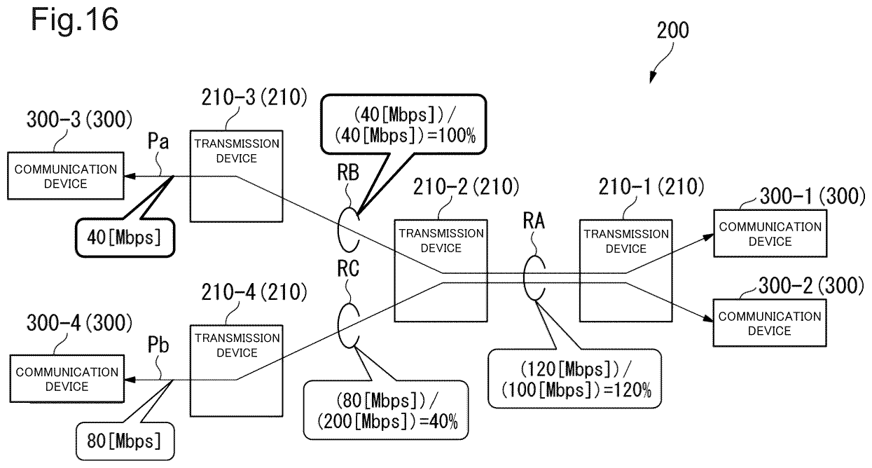

FIG. 16 is a diagram illustrating a sixth example of the state and setting of the communication network 200. FIG. 16 illustrates a second example in a case where the QoS calculation unit 192 adjusts the QoS parameter value for the first time from the example of FIG. 8.

Referring to FIG. 8 illustrating the state before calculation in the example of FIG. 16, the band usage rates of the transmission sections RA and RB are larger than the usage rate upper limit threshold. In the example of FIG. 16, the QoS calculation unit 192 selects the transmission section RB from the transmission sections RA and RB in which the band usage rate is larger than the threshold.

In the example of FIG. 16, the transmission section RB is relevant to an example of a transmission section in which a difference obtained by subtracting a threshold from a band usage rate is largest among transmission sections in which the band usage rate is larger than the threshold. The transmission section RB also is relevant to an example of a transmission section in which the number of communication paths passing through the transmission section is smallest among the transmission sections in which the band usage rate is larger than the threshold.

The QoS calculation unit 192 calculates the communication capacity of the communication path Pa passing through the transmission section RB such that the band usage rate in the selected transmission section RB becomes 100% that is the usage rate upper limit threshold.

Specifically, the QoS calculation unit 192 calculates the communication capacity of the communication path Pa to be 40 megabits per second equal to the transmission capacity of the transmission section RB.

The QoS calculation unit 192 calculates the band usage rate in the transmission section RB based on the calculated communication capacity as 40/40=100%. The QoS calculation unit 192 calculates the band usage rate in the transmission section RA based on the calculated communication capacity as (40+80)/100=¹20%.

As described above, the band usage rate is greater than 100% in the transmission section RA, and congestion may occur in the transmission section RA.

In the transmission section RA, the band usage rate is a value larger than the usage rate upper limit threshold. Therefore, the QoS calculation unit 192 recalculates the QoS parameter value such that the band usage rate is equal to or less than the threshold.

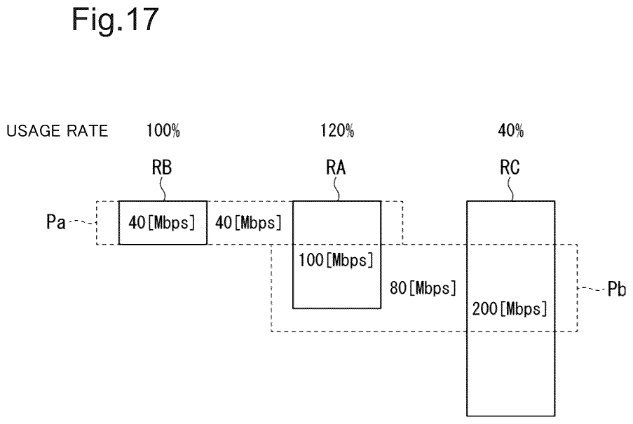

FIG. 17 is a diagram illustrating a sixth example of a bar-like representation of the state and setting of the communication network 200. FIG. 17 illustrates an example in which the state and setting of the communication network 200 based on the communication capacity calculated by the QoS calculation unit 192 in FIG. 16 are expressed in a bar graph manner.

Also in the example of FIG. 17, the transmission capacity in each of the transmission sections RA, RB, and RC is indicated by the height of a solid square. The communication capacity in each of the communication paths Pa and Pb is indicated by the height of a dashed square.

In the example of FIG. 17, the height indicating the transmission capacity in the transmission section RB is equal to the height indicating the communication capacity in the communication path Pa. This indicates that congestion does not occur in the transmission section RB.

On the other hand, the sum of the height indicating the communication capacity in the communication path Pa and the height indicating the communication capacity in the communication path Pb is larger than the height indicating the transmission capacity in the transmission section RA. This indicates that congestion may occur in the transmission section RA.

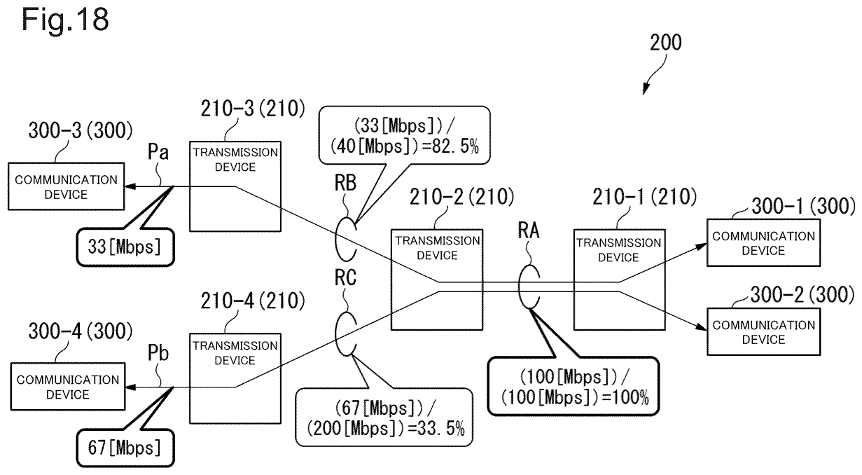

FIG. 18 is a diagram illustrating a seventh example of the state and setting of the communication network 200. FIG. 18 illustrates an example in a case where the QoS calculation unit 192 adjusts the QoS parameter value for the second time from the example of FIG. 16.

Referring to FIG. 16 illustrating a state before calculation in the example of FIG. 18, the transmission section in which the band usage rate is larger than the threshold is only the transmission section RA, and in the example of FIG. 18, the QoS calculation unit 192 selects the transmission section RA.

The QoS calculation unit 192 calculates the communication capacity of each of the communication paths Pa and Pb passing through the transmission section RA such that the band usage rate in the selected transmission section RA becomes 100% that is the usage rate upper limit threshold.

Specifically, the QoS calculation unit 192 calculates (40+80)−100=20 [Mbps] obtained by subtracting the transmission capacity in the transmission section RA from the sum of the (pre-change) communication capacities of the communication paths Pa and Pb as the communication capacity to be subtracted.

Then, the QoS calculation unit 192 distributes the communication capacities to be subtracted according to a ratio of 40:80 of the communication capacities of the communication paths Pa and Pb, and calculates the communication capacities to be subtracted for the communication paths Pa and Pb as 7 megabits per second and 13 megabits per second.

The QoS calculation unit 192 calculates the communication capacity of the communication path Pa as 40−7=33 [Mbps]. The QoS calculation unit 192 calculates the communication capacity of the communication path Pb as 80−13=67 [Mbps].

The QoS calculation unit 192 calculates the band usage rate in the transmission section RA based on the calculated communication capacity as (33+67)/100=100%. The QoS calculation unit 192 calculates the band usage rate in the transmission section RB based on the calculated communication capacity as 33/40=82.5%. The QoS calculation unit 192 calculates the band usage rate in the transmission section RC based on the calculated communication capacity as 67/200=33.5%.

In the example of FIG. 18, in any of the transmission sections RA, RB, and RC, the band usage rate is equal to or less than 100%, and it is considered that congestion does not occur.

In the transmission section RA through which both the communication paths Pa and Pb pass, the total communication capacity and the transmission capacity are equal. As a result, it can be determined that there is no margin of the transmission capacity for increasing the communication capacity for both the communication paths Pa and Pb.

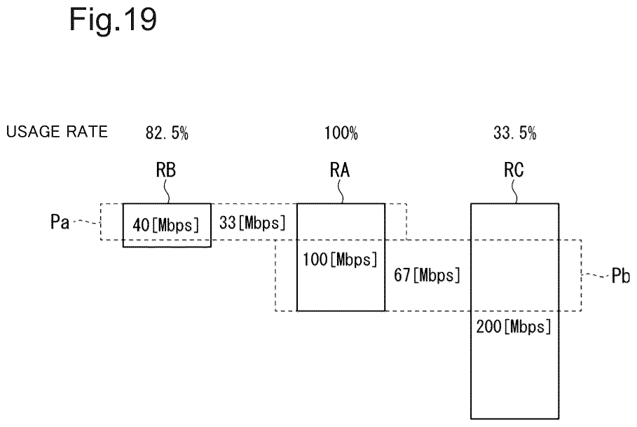

FIG. 19 is a diagram illustrating a seventh example of a bar-like representation of the state and setting of the communication network 200. FIG. 19 illustrates an example in which the state and setting of the communication network 200 based on the communication capacity calculated by the QoS calculation unit 192 in FIG. 18 are expressed in a bar graph manner.

Also in the example of FIG. 19, the transmission capacity in each of the transmission sections RA, RB, and RC is indicated by the height of a solid square. The communication capacity in each of the communication paths Pa and Pb is indicated by the height of a dashed square.

In the example of FIG. 19, in any of the transmission sections RA, RB, and RC, the height indicating the transmission capacity is greater than or equal to the sum of the heights indicating the communication capacity, and it is indicated that congestion does not occur.

In the example of FIG. 19, the total communication capacities and the transmission capacity are equal in the transmission section RA through which both the communication paths Pa and Pb pass. This indicates that there is no margin of the transmission capacity for increasing the communication capacity for both the communication paths Pa and Pb.

As in the example of FIG. 10, the QoS calculation unit 192 may select a transmission section in which a difference obtained by subtracting a threshold from a band usage rate is smallest among transmission sections in which the band usage rate is larger than the threshold. In this case, it can be understood that the QoS calculation unit 192 modifies the communication capacity by selecting the transmission section in which the modification amount (subtraction amount) of the communication capacity is minimized. The QoS calculation unit 192 can be regarded as gradually modifying the communication capacity, and in this respect, it is expected that the communication capacity can be modified in a relatively similar manner.

The modifying of the communication capacity in a relatively similar manner herein means that a modification ratio (a ratio of a modification amount of the communication capacity to an original communication capacity) or a modification amount differs relatively little for each communication path.

In the example of FIG. 10, it can also be understood that the QoS calculation unit 192 selects a transmission section in which the number of communication paths passing through the transmission section is largest among the transmission sections in which the band usage rate is larger than the threshold. In a case where the QoS calculation unit 192 performs such selection, it can be understood that the modification amount of the communication capacity is allocated to a relatively large number of communication paths. In this respect, it is expected that the QoS calculation unit 192 can modify the communication capacity relatively similarly.

Alternatively, as in the example of FIG. 16, the QoS calculation unit 192 may select a transmission section in which a difference obtained by subtracting a threshold from a band usage rate is largest among transmission sections in which the band usage rate is larger than the threshold. In this case, it can be understood that the QoS calculation unit 192 modifies the communication capacity by selecting the transmission section in which the modification amount (subtraction amount) of the communication capacity is maximized. The QoS calculation unit 192 can be regarded as modifying the communication capacity at once, and in this respect, it is expected that the number of times the QoS calculation unit 192 adjusts the QoS parameter value is relatively small.

In the example of FIG. 16, it can also be understood that the QoS calculation unit 192 selects a transmission section in which the number of communication paths passing through the transmission section is smallest among the transmission sections in which the band usage rate is larger than the threshold. In a case where the QoS calculation unit 192 performs such selection, the modification amount of the communication capacity is allocated to a relatively small number of communication paths, and it can be understood that the modification amount of the communication capacity in one communication path becomes relatively large. In this respect, it is expected that the number of times the QoS calculation unit 192 adjusts the QoS parameter value is relatively small.

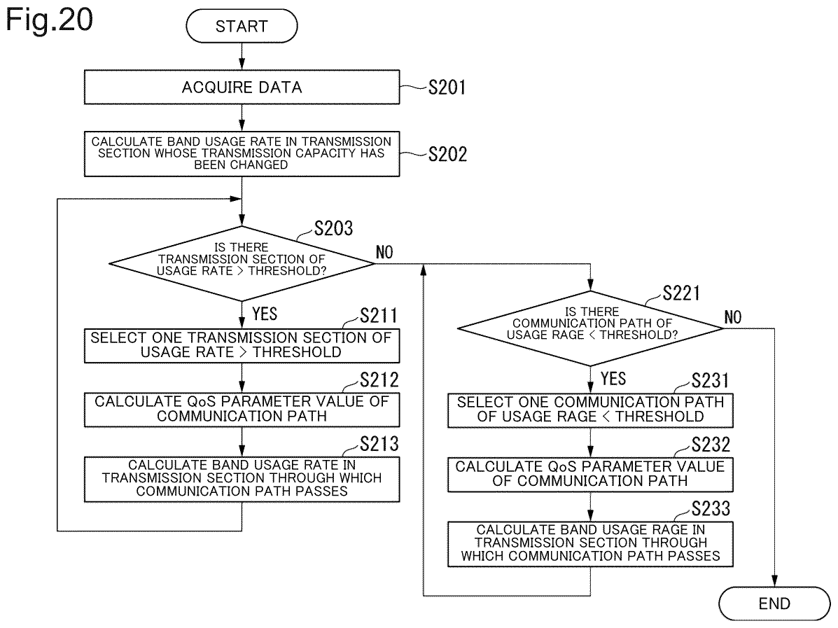

FIG. 20 is a diagram illustrating an example of a procedure of processing in which the QoS calculation unit 192 calculates QoS parameter values. The QoS calculation unit 192 performs the processing of FIG. 20 in steps S121 to S123 of FIG. 5.

In the processing of FIG. 20, the QoS calculation unit 192 acquires data to be used for calculation of QoS parameter values (step S201). For example, the QoS calculation unit 192 reads the transmission capacity information from the transmission capacity information storage unit 182 as illustrated in step S121 of FIG. 5. The QoS calculation unit 192 reads QoS information from the QoS information storage unit 183 as illustrated in step S122 of FIG. 5. The QoS calculation unit 192 reads the path information from the path information storage unit 181.

Next, for the transmission section in which the transmission capacity has changed, the QoS calculation unit 192 calculates a band usage rate based on the changed transmission capacity and the communication capacity set for the communication path passing through the transmission section (step S202). The changed transmission capacity is indicated in the transmission capacity information read from the transmission capacity information storage unit 182.

Next, the QoS calculation unit 192 determines whether there is a transmission section in which the band usage rate is larger than the usage rate upper limit threshold (step S203).

In a case where it is determined that there is a transmission section in which the band usage rate is larger than the usage rate upper limit threshold (step S203: YES), the QoS calculation unit 192 selects any one of the transmission sections in which the band usage rate is larger than the usage rate upper limit threshold (step S211).

The method by which the QoS calculation unit 192 selects any one of the transmission sections whose band usage rate is greater than the usage rate upper limit threshold is not limited to a specific method.

As described above, the QoS calculation unit 192 may select a transmission section in which a difference obtained by subtracting a threshold from a band usage rate is smallest among transmission sections in which the band usage rate is larger than the threshold. Alternatively, the QoS calculation unit 192 may select a transmission section in which a difference obtained by subtracting a threshold from a band usage rate is largest among transmission sections in which the band usage rate is larger than the threshold.

Alternatively, the QoS calculation unit 192 may select a transmission section in which the number of communication paths passing through the transmission section is largest among the transmission sections in which the band usage rate is larger than the threshold. The QoS calculation unit 192 may select a transmission section in which the number of communication paths passing through the transmission section is smallest among the transmission sections in which the band usage rate is larger than the threshold.

Alternatively, the QoS calculation unit 192 may randomly select any one of the transmission sections in which the band usage rate is larger than the threshold.

The QoS calculation unit 192 may select the transmission section by a different selection method for each repetition of the calculation of the QoS parameter value (in the example of FIG. 20, each repetition of the loop from steps S203 to S213).

Next, the QoS calculation unit 192 calculates the communication capacity of each communication path through which the selected transmission section passes such that the band usage rate in the transmission section is equal to the usage rate upper limit threshold (step S212).

Next, the QoS calculation unit 192 calculates a band usage rate in each communication section through which the communication path for which the communication capacity has been calculated passes (step S213).

After step S211, the process returns to step S203.

On the other hand, in a case where it is determined in step S203 that there is no transmission section in which the band usage rate is larger than the usage rate upper limit threshold (step S203: NO), the QoS calculation unit 192 determines the presence or absence of a communication path whose band usage rate is smaller than the usage rate upper limit threshold in all the transmission sections through which the communication path passes (step S221).

In a case where it is determined that there is a communication path whose band usage rate is lower than the usage rate upper limit threshold in all the transmission sections through which the communication path passes (step S221: YES), the QoS calculation unit 192 selects any one of the communication paths whose band usage rate is lower than the usage rate upper limit threshold in all the transmission sections through which the communication path passes (step S231). A method by which the QoS calculation unit 192 selects the communication path is not limited to a specific method.

Next, the QoS calculation unit 192 calculates the communication capacity in the communication section such that the band usage rate in at least one of the transmission sections through which the selected communication path passes is equal to the usage rate upper limit threshold (step S232).

Next, the QoS calculation unit 192 calculates a band usage rate in each transmission section through which the selected communication path passes (step S233).

After step S233, the process returns to step S221.

On the other hand, in a case where it is determined in step S221 that there is no communication path whose band usage rate is lower than the usage rate upper limit threshold in all the transmission sections through which the communication path passes (step S221: NO), the QoS calculation unit 192 ends the process of FIG. 20.

As described above, in a case where there is one or more transmission sections in which the band usage rate is larger than the usage rate upper limit threshold, the QoS calculation unit 192 selects one transmission section in which the band usage rate is larger than the usage rate upper limit threshold. The band usage rate in a certain transmission section is a ratio obtained by dividing a value obtained by summing communication capacities set for all communication paths passing through the transmission section by a transmission capacity in the transmission section. The usage rate upper limit threshold is a threshold set to the band usage rate.

Then, the QoS calculation unit 192 updates the communication capacity set to the communication path passing through the transmission section (selected transmission section) such that the band usage rate in the selected transmission section becomes equal to or less than the usage rate upper limit threshold.

The QoS calculation unit 192 repeats the selection of the transmission section and the update of the communication capacity until the band usage rate becomes equal to or less than the usage rate upper limit threshold in any of all the transmission sections.

According to the management device 100, even in a case where a plurality of communication paths pass through one transmission section in the communication network 200, communication settings can be dynamically updated so that congestion does not occur.

In particular, according to the management device 100, the communication capacity of each communication path can be adjusted such that the band usage rate in all the transmission sections becomes equal to or less than the usage rate upper limit threshold.

Here, if QoS is set in advance on the premise of a state in which the transmission capacity is maximized at the time of network design, congestion may occur when the transmission capacity deteriorates. On the other hand, if the QoS is set in advance on the assumption that the transmission capacity is minimized, the transmission capacity cannot be efficiently used at the normal time, and the resources of the wireless communication cannot be effectively used.

If the communication device dynamically changes the QoS setting, the QoS setting of another communication device is unknown, and congestion may occur, or the transmission capacity may not be efficiently used.

On the other hand, the management device 100 can prevent congestion from occurring and can efficiently use the transmission capacity by dynamically changing the QoS setting of each communication device 300.

The QoS calculation unit 192 updates the communication capacity set for the communication path passing through the transmission section (selected transmission section) such that the band usage rate in the selected transmission section is equal to the threshold (usage rate upper limit threshold) set for the transmission section (selected transmission section).

According to the management device 100, in particular, the transmission capacity can be efficiently used in that the transmission capacity of the selected transmission section is used up to the threshold.

In a case where there is a communication path whose band usage rate in all the transmission sections through which one communication path passes is smaller than the threshold, the QoS calculation unit 192 increases the communication capacity set for the communication path (communication path whose band usage rate in all the transmission sections through which one communication path passes is smaller than the threshold) within a range in which the band usage rate in all the transmission sections through which the communication path (communication path whose band usage rate in all the transmission sections through which one communication path passes is smaller than the threshold) passes is equal to or less than the threshold.

According to the management device 100, the transmission capacity can be more efficiently used within a range in which congestion does not occur.

The QoS calculation unit 192 further increases the communication capacity set to the communication path (communication path whose band usage rate in all the transmission sections through which one communication path passes is smaller than the threshold) such that the band usage rate in at least one transmission section through which the communication path (communication path whose band usage rate in all the transmission sections through which one communication path passes is smaller than the threshold) is equal to the threshold.

According to the management device 100, in particular, the transmission capacity can be efficiently used in that the transmission capacity of at least one transmission section is used up to the threshold.

The QoS calculation unit 192 selects a transmission section in which a difference obtained by subtracting a threshold from a band usage rate is smallest among transmission sections in which the band usage rate is larger than the threshold.

In this case, it can be understood that the QoS calculation unit 192 modifies the communication capacity by selecting the transmission section in which the modification amount (subtraction amount) of the communication capacity is minimized. The (QoS calculation unit 192 of) the management device 100 can be regarded as gradually modifying the communication capacity, and in this respect, it is expected that the communication capacity can be modified in a relatively similar manner.

As described above, the modifying of the communication capacity in a relatively similar manner herein means that a modification ratio (a ratio of a modification amount of the communication capacity to an original communication capacity) or a modification amount differs relatively little for each communication path.

The QoS calculation unit 192 selects a transmission section in which the number of communication paths passing through the transmission section is largest among the transmission sections in which the band usage rate is larger than the threshold.

In this case, it can be understood that the QoS calculation unit 192 allocates the modification amount of the communication capacity to a relatively large number of communication paths. In this respect, it is expected that (the QoS calculation unit 192 of) the management device 100 can modify the communication capacity relatively similarly.

The QoS calculation unit 192 selects a transmission section in which a difference obtained by subtracting a threshold from a band usage rate is largest among transmission sections in which the band usage rate is larger than the threshold.

In this case, it can be understood that the QoS calculation unit 192 modifies the communication capacity by selecting the transmission section in which the modification amount (subtraction amount) of the communication capacity is maximized. The QoS calculation unit 192 can be regarded as modifying the communication capacity at once, and in this respect, it is expected that the number of times (the QoS calculation unit 192 of) the management device 100 adjusts the QoS parameter value is relatively small.

The QoS calculation unit 192 selects a transmission section in which the number of communication paths passing through the transmission section is smallest among the transmission sections in which the band usage rate is larger than the threshold.

In this case, the QoS calculation unit 192 allocates the modification amount of the communication capacity to a relatively small number of communication paths, and it can be understood that the modification amount of the communication capacity in one communication path becomes relatively large. In this respect, it is expected that the number of times (the QoS calculation unit 192 of) the management device 100 adjusts the QoS parameter value is relatively small.

### Second Example Embodiment

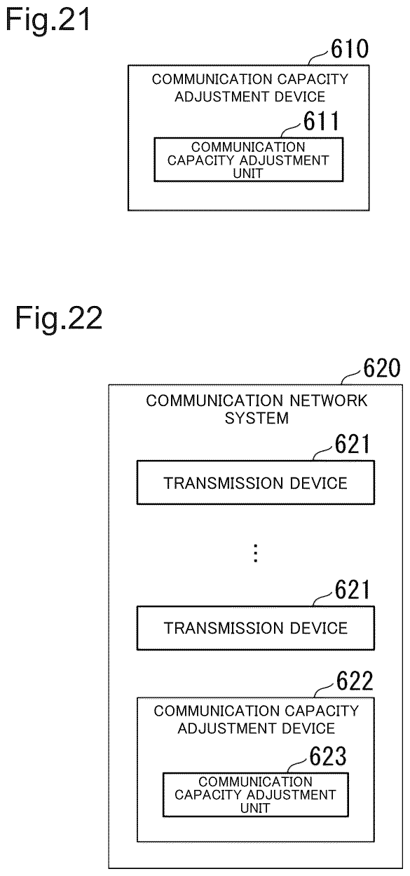

FIG. 21 is a diagram illustrating an example of a configuration of a communication capacity adjustment device according to at least one example embodiment. In the configuration illustrated in FIG. 21, a communication capacity adjustment device 610 includes a communication capacity adjustment unit 611.

In such a configuration, in a case where there is one or more transmission sections in which the band usage rate is larger than the threshold, the communication capacity adjustment unit 611 repeats selecting one transmission section in which the band usage rate is larger than the threshold, and updating the communication capacity set to the communication path passing through the selected transmission section (selected transmission section) so that the band usage rate in the selected transmission section becomes equal to or less than the threshold until the band usage rate becomes equal to or less than the threshold in any of all the transmission sections.

The band usage rate is a ratio obtained by dividing a value obtained by summing communication capacities set for all communication paths passing through one transmission section in a communication network by a transmission capacity in each transmission section. The band usage rate is calculated for each transmission section.

The communication capacity adjustment unit 611 is relevant to an example of a communication capacity update means.

According to the communication capacity adjustment device 610, even in a case where a plurality of communication paths pass through one transmission section in the communication network, communication settings can be dynamically updated so that congestion does not occur. In particular, according to the communication capacity adjustment device 610, the communication capacity of each communication path can be adjusted such that the band usage rate in all the transmission sections becomes equal to or less than the threshold.

### Third Example Embodiment

FIG. 22 is a diagram illustrating an example of a configuration of a communication network system according to at least one example embodiment. In the configuration illustrated in FIG. 22, a communication network system 620 includes a transmission device 621 and a communication capacity adjustment device 622. The communication capacity adjustment device 622 includes a communication capacity adjustment unit 623.

With such a configuration, in a case where there is one or more transmission sections in which the band usage rate is larger than the threshold among transmission sections that are portions between two transmission devices 621 that directly perform communication in the communication network by the transmission device 621, the communication capacity adjustment device 622 repeats selecting one transmission section in which the band usage rate is larger than the threshold and updating the communication capacity set for the communication path passing through the transmission section (selected transmission section) so that the band usage rate in the selected transmission section becomes equal to or less than the threshold until the band usage rate becomes equal to or less than the threshold in all the transmission sections.

The band usage rate is a ratio obtained by dividing a value obtained by summing communication capacities set for all communication paths passing through one transmission section by a transmission capacity in each transmission section.

The communication capacity adjustment device 622 is relevant to an example of a communication capacity update means.

According to the communication network system 620, even in a case where a plurality of communication paths pass through one transmission section in the communication network, communication settings can be dynamically updated so that congestion does not occur. In particular, according to the communication network system 620, the communication capacity of each communication path can be adjusted such that the band usage rate in all the transmission sections becomes equal to or less than the threshold.

### Fourth Example Embodiment

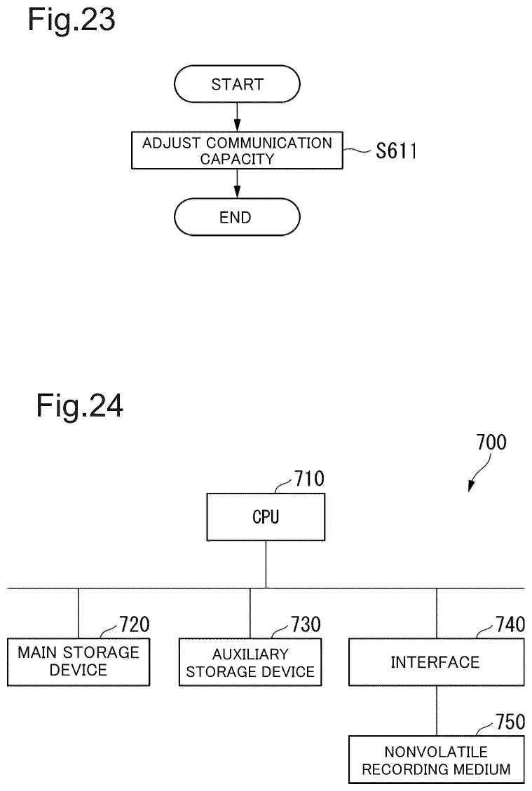

FIG. 23 is a diagram illustrating an example of a procedure of processing in a communication capacity adjustment method according to at least one example embodiment. The communication capacity adjustment method illustrated in FIG. 23 includes adjusting the communication capacity (step S611).

Adjusting the communication capacity (step S611) includes repeating, by the computer, in a case where there is one or more transmission sections in which the band usage rate is larger than the threshold, selecting one transmission section in which the band usage rate is larger than the threshold, and updating the communication capacity set to the communication path passing through the selected transmission section (selected transmission section) so that the band usage rate in the selected transmission section becomes equal to or less than the threshold until the band usage rate becomes equal to or less than the threshold in any of all the transmission sections.

The band usage rate is a ratio obtained by dividing a value obtained by summing communication capacities set for all communication paths passing through one transmission section in a communication network by a transmission capacity in each transmission section. The band usage rate is calculated for each transmission section.

According to the communication capacity adjustment method illustrated in FIG. 23, even in a case where a plurality of communication paths pass through one transmission section in the communication network, communication settings can be dynamically updated so that congestion does not occur. In particular, according to the communication capacity adjustment method illustrated in FIG. 23, the communication capacity of each communication path can be adjusted such that the band usage rate in all the transmission sections becomes equal to or less than the threshold.

FIG. 24 is a diagram illustrating an example of a configuration of a computer according to at least one example embodiment.

In the configuration illustrated in FIG. 24, a computer 700 includes a CPU 710, a main storage device 720, an auxiliary storage device 730, an interface 740, and a nonvolatile recording medium 750.

Any one or more of the management device 100, the communication capacity adjustment device 610, and the communication capacity adjustment device 622 described above or a part thereof may be implemented in the computer 700. In this case, the operation of each processing unit described above is stored in the auxiliary storage device 730 in the form of a program. The CPU 710 reads the program from the auxiliary storage device 730, develops the program in the main storage device 720, and executes the above processing according to the program. The CPU 710 secures a storage area related to each of the above-described storage units in the main storage device 720 according to the program. Communication between each device and another device is executed by the interface 740 having a communication function and performing communication under the control of the CPU 710. The interface 740 has a port for the nonvolatile recording medium 750, and reads information from the nonvolatile recording medium 750 and writes information to the nonvolatile recording medium 750.

In a case where the management device 100 is mounted in the computer 700, the operation of the management-side processing unit 190 and each unit thereof is stored in the auxiliary storage device 730 in the form of a program. The CPU 710 reads the program from the auxiliary storage device 730, develops the program in the main storage device 720, and executes the above processing according to the program.

The CPU 710 secures a storage area for the management-side storage unit 180 in the main storage device 720 according to the program. Communication with another device by the management-side communication unit 110 is executed by allowing the interface 740 having a communication function to be operated under the control of the CPU 710. The interaction between the management device 100 and the user is executed when the interface 740 includes an input device and an output device, information is presented to the user by the output device according to the control of the CPU 710, and a user operation is received by the input device.

In a case where the communication capacity adjustment device 610 is implemented in the computer 700, the operation of the communication capacity adjustment unit 611 is stored in the auxiliary storage device 730 in the form of a program. The CPU 710 reads the program from the auxiliary storage device 730, develops the program in the main storage device 720, and executes the above processing according to the program.

The CPU 710 secures a storage area for the communication capacity adjustment device 610 to perform processing in the main storage device 720 according to the program. Communication between the communication capacity adjustment device 610 and another device is executed by the interface 740 having a communication function and operating under the control of the CPU 710. The interaction between the communication capacity adjustment device 610 and the user is executed when the interface 740 includes an input device and an output device, information is presented to the user by the output device according to the control of the CPU 710, and a user operation is received by the input device.

In a case where the communication capacity adjustment device 622 is implemented in the computer 700, the operation of the communication capacity adjustment unit 623 is stored in the auxiliary storage device 730 in the form of a program. The CPU 710 reads the program from the auxiliary storage device 730, develops the program in the main storage device 720, and executes the above processing according to the program.

The CPU 710 secures a storage area for the communication capacity adjustment device 622 to perform processing in the main storage device 720 according to the program. Communication between the communication capacity adjustment device 622 and another device is executed by the interface 740 having a communication function and operating under the control of the CPU 710. The interaction between the communication capacity adjustment device 622 and the user is executed when the interface 740 includes an input device and an output device, information is presented to the user by the output device according to the control of the CPU 710, and a user operation is received by the input device.

Any one or more of the above-described programs may be recorded in the nonvolatile recording medium 750. In this case, the interface 740 may read the program from the nonvolatile recording medium 750. The CPU 710 may directly execute the program read by the interface 740, or may temporarily store the program in the main storage device 720 or the auxiliary storage device 730 and execute the program.

A program for executing all or part of the processing performed by the management device 100, the communication capacity adjustment device 610, and the communication capacity adjustment device 622 may be recorded in a computer-readable recording medium, and the processing of each unit may be performed by causing a computer system to read and execute the program recorded in the recording medium. The “computer system” herein includes hardware such as an operating system (OS) and peripheral devices.

The “computer-readable recording medium” refers to a portable medium such as a flexible disk, a magneto-optical disk, a read only memory (ROM), and a compact disc read only memory (CD-ROM), and a storage device such as a hard disk built in a computer system. The program may be for implementing some of the functions described above, and the functions described above may be implemented in combination with a program already recorded in the computer system.

While the present disclosure has been particularly shown and described with reference to this example embodiment, the present disclosure is not limited to the above-described example embodiment. It will be understood by those of ordinary skill in the art that various changes in form and details may be made therein without departing from the spirit and scope of the present disclosure as defined by the claims. The above-described example embodiments may be appropriately combined with other example embodiments.

Some or all of the above-described example embodiments may be described as the following supplementary notes, but are not limited to the following supplementary notes.

### Supplementary Note 1

A communication capacity adjustment device including
a communication capacity update means for, in a case where there is one or more transmission sections in which a band usage rate for each transmission section is larger than a threshold, the band usage rate being a ratio obtained by dividing a value obtained by summing communication capacities set for all communication paths passing through one transmission section in a communication network by a transmission capacity set to each transmission section, repeating selecting one transmission section in which the band usage rate is larger than the threshold, and updating a communication capacity set for a communication path passing through the selected transmission section in such a way that the band usage rate in the selected transmission section becomes equal to or less than the threshold until the band usage rate becomes equal to or less than the threshold in any of all the transmission sections.

### Supplementary Note 2

The communication capacity adjustment device according to Supplementary Note 1, in which
the communication capacity update means updates a communication capacity set to a communication path passing through the selected transmission section in such a way that a band usage rate in the selected transmission section becomes equal to a threshold set to the selected transmission section.

### Supplementary Note 3

The communication capacity adjustment device according to Supplementary Note 1 or 2, in which
in a case where there is a communication path whose band usage rate in all transmission sections through which one communication path passes is smaller than a threshold, the communication capacity update means increases a communication capacity set to a communication path whose band usage rate in all the transmission sections through which the one communication path passes is smaller than the threshold within a range in which the band usage rate in all the transmission sections through which a communication path whose band usage rate in all the transmission sections through which the one communication path passes is smaller than the threshold is equal to or less than the threshold.

### Supplementary Note 4

The communication capacity adjustment device according to Supplementary Note 3, in which
the communication capacity update means further increases a communication capacity set to a communication path whose band usage rate in all transmission sections through which the one communication path passes is smaller than a threshold in such a way that a band usage rate in at least one transmission section through which a communication path whose band usage rate in all transmission sections through which the one communication path passes is smaller than the threshold is equal to the threshold.

### Supplementary Note 5

The communication capacity adjustment device according to any one of Supplementary Notes 1 to 4, in which
the communication capacity update means selects a transmission section in which a difference obtained by subtracting a threshold from a band usage rate is smallest among transmission sections in which the band usage rate is larger than the threshold.

### Supplementary Note 6

The communication capacity adjustment device according to any one of Supplementary Notes 1 to 5, in which
the communication capacity update means selects a transmission section having a largest number of communication paths passing through the transmission section having a band usage rate larger than a threshold.

### Supplementary Note 7

The communication capacity adjustment device according to any one of Supplementary Notes 1 to 6, in which
the communication capacity update means selects a transmission section having a largest difference obtained by subtracting a threshold from a band usage rate among transmission sections in which the band usage rate is larger than the threshold.

### Supplementary Note 8

The communication capacity adjustment device according to any one of Supplementary Notes 1 to 7, in which
the communication capacity update means selects a transmission section having a smallest number of communication paths passing through the transmission section having a band usage rate larger than a threshold.

### Supplementary Note 9

A communication network system, including:
a transmission device; and a communication capacity adjustment device,
in which the communication capacity adjustment device includes
a communication capacity update means for repeating, in a case where there is one or more transmission sections in which a band usage rate for each transmission section is larger than a threshold, the band usage rate being a ratio obtained by dividing a value obtained by summing communication capacities set for all communication paths passing through one transmission section in a communication network by a transmission capacity set to each transmission section, among transmission sections that are portions between two transmission devices that directly perform communication in a communication network by the transmission device, selecting one transmission section in which the band usage rate is larger than the threshold, and updating a communication capacity set for a communication path passing through the selected transmission section in such a way that the band usage rate in the selected transmission section becomes equal to or less than the threshold until the band usage rate in all the transmission sections becomes equal to or less than the threshold set to the selected transmission section.

### Supplementary Note 10

The communication network system according to Supplementary Note 9, in which
the communication capacity update means updates a communication capacity set to a communication path passing through the selected transmission section in such a way that a band usage rate in the selected transmission section becomes equal to a threshold set to the selected transmission section.

### Supplementary Note 11

The communication network system according to Supplementary Note 9 or 10, in which
in a case where there is a communication path whose band usage rate in all transmission sections through which one communication path passes is smaller than a threshold, the communication capacity update means increases a communication capacity set to a communication path whose band usage rate in all the transmission sections through which the one communication path passes is smaller than the threshold within a range in which the band usage rate in all the transmission sections through which a communication path whose band usage rate in all the transmission sections through which the one communication path passes is smaller than the threshold is equal to or less than the threshold.

### Supplementary Note 12

The communication network system according to Supplementary Note 11, in which
the communication capacity update means further increases a communication capacity set to a communication path whose band usage rate in all transmission sections through which the one communication path passes is smaller than a threshold in such a way that a band usage rate in at least one transmission section through which a communication path whose band usage rate in all transmission sections through which the one communication path passes is smaller than the threshold is equal to the threshold.

### Supplementary Note 13

The communication network system according to any one of Supplementary Notes 9 to 12, in which
the communication capacity update means selects a transmission section in which a difference obtained by subtracting a threshold from a band usage rate is smallest among transmission sections in which the band usage rate is larger than the threshold.

### Supplementary Note 14

The communication network system according to any one of Supplementary Notes 9 to 13, in which
the communication capacity update means selects a transmission section having a largest number of communication paths passing through the transmission section having a band usage rate larger than a threshold.

### Supplementary Note 15

The communication network system according to any one of Supplementary Notes 9 to 14, in which
the communication capacity update means selects a transmission section in which a difference obtained by subtracting a threshold from a band usage rate is largest among transmission sections in which the band usage rate is larger than the threshold.

### Supplementary Note 16

The communication network system according to any one of Supplementary Notes 9 to 15, in which
the communication capacity update means selects a transmission section having a smallest number of communication paths passing through the transmission section having a band usage rate larger than a threshold.

### Supplementary Note 17

A communication capacity adjustment method for causing a computer to execute:
repeating, in a case where there is one or more transmission sections in which a band usage rate for each transmission section is larger than a threshold, the band usage rate being a ratio obtained by dividing a value obtained by summing communication capacities set for all communication paths passing through one transmission section in a communication network by a transmission capacity set to each transmission section, selecting one transmission section in which the band usage rate is larger than the threshold, and updating a communication capacity set for a communication path passing through the selected transmission section in such a way that the band usage rate in the selected transmission section becomes equal to or less than the threshold until the band usage rate in all the transmission sections becomes equal to or less than the threshold set to the selected transmission section.

### Supplementary Note 18

The communication capacity adjustment method according to Supplementary Note 17, in which
in the updating of the communication capacity, the computer updates a communication capacity set to a communication path passing through the selected transmission section in such a way that a band usage rate in the selected transmission section becomes equal to a threshold set to the selected transmission section.

### Supplementary Note 19

The communication capacity adjustment method according to Supplementary Note 17 or 18, in which
in the updating of the communication capacity, in a case where there is a communication path whose band usage rate in all transmission sections through which one communication path passes is smaller than a threshold, the computer increases a communication capacity set to a communication path whose band usage rate in all the transmission sections through which the one communication path passes is smaller than the threshold within a range in which the band usage rate in all the transmission sections through which a communication path whose band usage rate in all the transmission sections through which the one communication path passes is smaller than the threshold is equal to or less than the threshold.

### Supplementary Note 20

The communication capacity adjustment method according to Supplementary Note 19, in which
in the updating of the communication capacity, the computer further increases a communication capacity set to a communication path whose band usage rate in all transmission sections through which the one communication path passes is smaller than a threshold in such a way that a band usage rate in at least one transmission section through which a communication path whose band usage rate in all transmission sections through which the one communication path passes is smaller than the threshold is equal to the threshold.

### Supplementary Note 21

The communication capacity adjustment method according to any one of Supplementary Notes 17 to 20, in which
in the updating of the communication capacity, the computer selects a transmission section in which a difference obtained by subtracting a threshold from a band usage rate is smallest among transmission sections in which the band usage rate is larger than the threshold.

### Supplementary Note 22

The communication capacity adjustment method according to any one of Supplementary Notes 17 to 21, in which
in the updating of the communication capacity, the computer selects a transmission section having a largest number of communication paths passing through the transmission section having a band usage rate larger than a threshold.

### Supplementary Note 23

The communication capacity adjustment method according to any one of Supplementary Notes 17 to 22, in which
in the updating of the communication capacity, the computer selects a transmission section in which a difference obtained by subtracting a threshold from a band usage rate is largest among transmission sections in which the band usage rate is larger than the threshold.

### Supplementary Note 24

The communication capacity adjustment method according to any one of Supplementary Notes 17 to 23, in which
in the updating of the communication capacity, the computer selects a transmission section having a smallest number of communication paths passing through the transmission section having a band usage rate larger than a threshold.

### Supplementary Note 25

A program for causing a computer to execute:
repeating, in a case where there is one or more transmission sections in which a band usage rate for each transmission section is larger than a threshold, the band usage rate being a ratio obtained by dividing a value obtained by summing communication capacities set for all communication paths passing through one transmission section in a communication network by a transmission capacity set to each transmission section, selecting one transmission section in which the band usage rate is larger than the threshold, and updating a communication capacity set for a communication path passing through the selected transmission section in such a way that the band usage rate in the selected transmission section becomes equal to or less than the threshold until the band usage rate in all the transmission sections becomes equal to or less than the threshold set to the selected transmission section.

### Supplementary Note 26

The program according to Supplementary Note 25, in which
in the updating of the communication capacity, the computer executes updating a communication capacity set to a communication path passing through the selected transmission section in such a way that a band usage rate in the selected transmission section becomes equal to a threshold set to the selected transmission section.

### Supplementary Note 27

The program according to Supplementary Note 25 or 26, in which
in the updating of the communication capacity, in a case where there is a communication path whose band usage rate in all transmission sections through which one communication path passes is smaller than a threshold, the computer executes increasing a communication capacity set to a communication path whose band usage rate in all the transmission sections through which the one communication path passes is smaller than the threshold within a range in which the band usage rate in all the transmission sections through which a communication path whose band usage rate in all the transmission sections through which the one communication path passes is smaller than the threshold is equal to or less than the threshold.

### Supplementary Note 28

The program according to Supplementary Note 27, in which
in the updating of the communication capacity, the computer further executes increasing a communication capacity set to a communication path whose band usage rate in all transmission sections through which the one communication path passes is smaller than a threshold in such a way that a band usage rate in at least one transmission section through which a communication path whose band usage rate in all transmission sections through which the one communication path passes is smaller than the threshold is equal to the threshold.

### Supplementary Note 29

The program according to any one of Supplementary Notes 25 to 28, in which
in the updating of the communication capacity, the computer executes selecting a transmission section in which a difference obtained by subtracting a threshold from a band usage rate is smallest among transmission sections in which the band usage rate is larger than the threshold.

### Supplementary Note 30

The program according to any one of Supplementary Notes 25 to 29, in which
in the updating of the communication capacity, the computer executes selecting a transmission section having a largest number of communication paths passing through the transmission section having a band usage rate larger than a threshold.

### Supplementary Note 31

The program according to any one of Supplementary Notes 25 to 30, in which
in the updating of the communication capacity, the computer executes selecting a transmission section in which a difference obtained by subtracting a threshold from a band usage rate is largest among transmission sections in which the band usage rate is larger than the threshold.

### Supplementary Note 32

The program according to any one of Supplementary Notes 25 to 31, in which
in the updating of the communication capacity, the computer executes selecting a transmission section having a smallest number of communication paths passing through the transmission section having a band usage rate larger than a threshold.

1. A communication capacity adjustment device comprising:
at least one memory that is configured to store instructions; and
at least one processor that is configured to execute the instructions to:
in a case where there is one or more transmission sections in which a band usage rate for each transmission section is larger than a threshold, the band usage rate being a ratio obtained by dividing a value obtained by summing communication capacities set for all communication paths passing through one transmission section in a communication network by a transmission capacity set to each transmission section, repeat selecting one transmission section in which the band usage rate is larger than the threshold, and update a communication capacity set for a communication path passing through the selected transmission section in such a way that the band usage rate in the selected transmission section becomes equal to or less than the threshold until the band usage rate becomes equal to or less than the threshold in any of all the transmission sections.

2. The communication capacity adjustment device according to claim 1, wherein the at least one processor further executes the instructions to:
update a communication capacity set to a communication path passing through the selected transmission section in such a way that a band usage rate in the selected transmission section becomes equal to a threshold set to the selected transmission section.

3. The communication capacity adjustment device according to claim 1, wherein the at least one processor further executes the instructions to:
in a case where there is a communication path whose band usage rate in all transmission sections through which one communication path passes is smaller than a threshold, increase a communication capacity set to a communication path whose band usage rate in all the transmission sections through which the one communication path passes is smaller than the threshold within a range in which the band usage rate in all the transmission sections through which a communication path whose band usage rate in all the transmission sections through which the one communication path passes is smaller than the threshold is equal to or less than the threshold.

4. The communication capacity adjustment device according to claim 3, wherein the at least one processor further executes the instructions to:
increase a communication capacity set to a communication path whose band usage rate in all transmission sections through which the one communication path passes is smaller than a threshold in such a way that a band usage rate in at least one transmission section through which a communication path whose band usage rate in all transmission sections through which the one communication path passes is smaller than the threshold passes is equal to the threshold.

5. The communication capacity adjustment device according to claim 1, wherein the at least one processor further executes the instructions to:
select a transmission section in which a difference obtained by subtracting a threshold from a band usage rate is smallest among transmission sections in which the band usage rate is larger than the threshold.

6. The communication capacity adjustment device according to claim 1, wherein the at least one processor further executes the instructions to:
select a transmission section having a largest number of communication paths passing through the transmission section having a band usage rate larger than a threshold.

7. The communication capacity adjustment device according to claim 1, wherein the at least one processor further executes the instructions to:
select a transmission section having a largest difference obtained by subtracting a threshold from a band usage rate among transmission sections in which the band usage rate is larger than the threshold.

8. A communication network system, comprising:
transmission devices; and
the communication capacity adjustment device according to claim 1,
wherein the transmission sections are portions between two of the transmission devices that directly perform communication in a communication network including the transmission devices.

9. A communication capacity adjustment method for causing a computer to execute:
repeating, in a case where there is one or more transmission sections in which a band usage rate for each transmission section is larger than a threshold, the band usage rate being a ratio obtained by dividing a value obtained by summing communication capacities set for all communication paths passing through one transmission section in a communication network by a transmission capacity set to each transmission section, selecting one transmission section in which the band usage rate is larger than the threshold, and updating a communication capacity set for a communication path passing through the selected transmission section in such a way that the band usage rate in the selected transmission section becomes equal to or less than the threshold until the band usage rate in all the transmission sections becomes equal to or less than the threshold set to the selected transmission section.

10. A tangible and non-transitory recording medium storing a program for causing a computer to execute:
repeating, in a case where there is one or more transmission sections in which a band usage rate for each transmission section is larger than a threshold, the band usage rate being a ratio obtained by dividing a value obtained by summing communication capacities set for all communication paths passing through one transmission section in a communication network by a transmission capacity set to each transmission section, selecting one transmission section in which the band usage rate is larger than the threshold, and updating a communication capacity set for a communication path passing through the selected transmission section in such a way that the band usage rate in the selected transmission section becomes equal to or less than the threshold until the band usage rate in all the transmission sections becomes equal to or less than the threshold set to the selected transmission section.
